(19) United States
(12) Patent Application Publication
(10) Pub. No.: US 2019/0241060 A1
(43) Pub. Date: Aug. 8, 2019

(54) Control System Of Blowing Means For Construction Machines

(71) Applicant: Caterpillar SARL, Geneva (CH)

(72) Inventors: Keigo Hara, Akashi-shi (JP); Yoshihiko Hata, Akashi-shi (JP)

(73) Assignee: Caterpillar SARL, Geneva (CH)

(21) Appl. No.: 16/317,212

(22) PCT Filed: Jul. 10, 2017
(86) PCT No.: PCT/EP2017/067280

§ 371 Date: Jan. 11, 2019

(30) Foreign Application Priority Data
Jul. 14, 2016 (JP) 2016-139318

(51) Int. Cl. B60K 11/06; F01P 7/04; E02F 9/08; E02F 9/20; B60K 11/04

(52) U.S. Cl. CPC B60K 11/06; F01P 7/048; E02F 9/0866; B60K 2025/005; B60K 11/04; F01P 2025/30; E02F 9/2095

(57) ABSTRACT

To provide a control system of blowing means for construction machines that enables to prevent the loss of battery charging amount even if an engine rotation speed is low and an alternator generates less electricity. A control system 2 of blowing means for construction machines comprises a heat exchanging means, a blowing means for blowing air to the heat exchanging means, an electric driving means for driving the blowing means, a temperature detecting means for detecting temperature of fluids running through the heat exchanging means, an alternator 4 generating electricity by being driven by an engine 34, and a control means for determining an upper limit rotation speed of the electric driving means based on current generated by the alternator 4 and controlling a rotation speed of the electric driving means based on temperature detected by the temperature detecting means while the rotation speed is below the upper limit rotation speed.

### FIELD OF THE INVENTION

The present invention relates to a control system of blowing means for construction machines.

### DESCRIPTION OF THE RELATED ART

Construction machines, e.g. a hydraulic excavator, are generally equipped with heat exchanging means, such as a radiator for cooling engine cooling water and an oil cooler for cooling hydraulic oil that operates hydraulic actuator. Open air is supplied as cooling air by a fan to the heat exchanging means. The fan is driven by either an engine to output shaft of which the fan is coupled via belt or viscous scratch or an electric motor (e.g., see PTLs 1, 2).

### CITATION LIST

### Patent Documents

PTL 1: Japanese Unexamined Patent Application Publication No. 2000-120438

PTL 2: Japanese Unexamined Patent Application Publication No. 2000-337144

### SUMMARY OF INVENTION

### Problems to be Solved by the Invention

If the construction machines are equipped with fans driven by electric motors, when an engine rotation speed is reduced along with reduced work load, an amount of electricity generated by an alternator coupled to an output shaft of the engine may be reduced so that a battery charging amount may be lost due to e.g. rotations of electric motor driving the fan.

In consideration of what mentioned above, the task of the present invention is to provide a control system of blowing means for construction machines that enables to prevent loss of the battery charging amount even if the engine rotation speed is low and the alternator generates less electricity.

### Means for Solving the Problem

In order to solve the task above, this invention provides a control system of blowing means for construction machines described below. Namely, this invention provides the control system of blowing means for construction machines that has a heat exchanging means, a blowing means for blowing air to the heat exchanging means, an electric driving means for driving the blowing means, a temperature detecting means for detecting temperature of fluids running through the heat exchanging means, an alternator generating electricity by being driven by an engine, and a control means for determining an upper limit rotation speed of the electric driving means based on current generated by the alternator and controlling rotation speed of the electric driving means based on the temperature detected by the temperature detecting means while the rotation speed is below the upper limit rotation speed.

Preferably, the heat exchanging means has a plurality of heat exchangers, the blowing means has a plurality of fans disposed facing to the each of a plurality of heat exchangers, the electric driving means has a plurality of electric motors driving the each of a plurality of fans, the temperature detecting means has a plurality of temperature sensors detecting temperature of fluids running through the each of a plurality of heat exchangers, and the control means determines the upper limit rotation speed of the each of a plurality of electric motors based on the current generated by the alternator and controls the each rotation speed of a plurality of electric motors based on the temperature detected by the each of a plurality of temperature sensors while the rotation speed is below the upper limit rotation speed. Suitably, the control means has a rotation speed detection means for detecting the engine rotation speed, the control means already stores a mapping of an alternator rotation speed to the engine rotation speed and a mapping of the current generated by the alternator to the alternator rotation speed, and the control means computes the alternator rotation speed based on the engine rotation speed detected by the rotation speed detection means and computes the current generated by the alternator based on the alternator rotation speed computed.

### Effects of the Invention

In the control system of blowing means for construction machines provided by an embodiment of this invention, since the control means determines the upper limit rotation speed of the electric driving means based on the current generated by the alternator and controls the rotation speed of the electric driving means based on the temperature detected by the temperature detecting means while the rotation speed is below the upper limit rotation speed, the loss of the battery charging amount can be prevented even if the engine rotation speed is low and the alternator generates less electricity.

### BRIEF DESCRIPTION OF THE DRAWINGS

FIG. 1 is a block diagram illustrating the control system of blowing means for construction machines.

FIG. 2 is a mapping of generated current to alternator rotation speed.

FIG. 3 is a mapping between engine cooling water temperature and rotation speed of an electric radiator fan motor.

FIG. 4 is a mapping between hydraulic oil temperature and rotation speed of an electric oil cooler fan motor.

FIG. 5 is a mapping between air temperature and rotation speed of an electric aftercooler fan motor.

### DESCRIPTION OF THE EMBODIMENTS

Now, the embodiment of the control system of blowing means for construction machines configured according to the present invention will be described with reference to the drawings above.

The control system of blowing means for construction machines a whole of which is shown with a reference numeral 2 has the heat exchanging means, the blowing means, the electric driving means, the temperature detecting means, an alternator 4, and a control means 6.

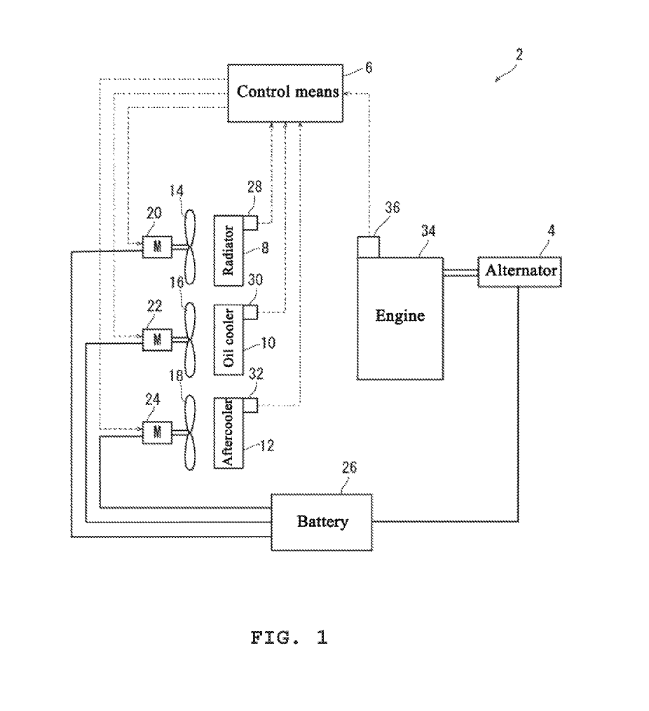

In the embodiment illustrated in FIG. 1, the heat exchanging means has a plurality of heat exchangers, the blowing means has a plurality of fans disposed respectively facing to each of heat exchangers, the electric driving means has a plurality of electric motors for driving each of fans, and the temperature detecting means has a plurality of temperature sensors for detecting temperature of fluids running through each of heat exchangers. In more detail, the heat exchanging means has a radiator 8 where engine cooling water runs through, an oil cooler 10 where hydraulic oil runs through, and an aftercooler 12 where air compressed by a supercharger (not shown) runs through. The blowing means for blowing air to the heat exchanging means has a radiator fan 14 disposed facing to the radiator 8, an oil cooler fan 16 disposed facing to the oil cooler 10, and an aftercooler fan 18 disposed facing to the aftercooler 12.

The electric driving means has an electric radiator fan motor 20 for driving the radiator fan 14, an electric oil cooler fan motor 22 for driving the oil cooler fan 16, and an electric aftercooler fan motor 24 for driving then aftercooler fan 18. Electric power is supplied to each electric motor 20, 22, or 24 from a battery 26 that is electrically connected to each electric motor 20, 22, or 24. Each solid line connecting each electric motor 20, 22, or 24 to the battery 26 in FIG. 1 illustrates an electric power supply line.

The temperature detecting means has a cooling water temperature sensor 28 for detecting temperature TR of the engine cooling water running through the radiator 8, a hydraulic oil temperature sensor 30 for detecting temperature TH of the hydraulic oil running through the oil cooler 10, and an air temperature sensor 32 for detecting temperature TA of the air running through the aftercooler 12. Note that the cooling water temperature sensor 28 may be disposed further on an upstream side of an engine thermostat (not shown) located on an upstream side of the radiator 8. The hydraulic oil temperature sensor 30 may be disposed further on a downstream side of a hydraulic tank (not shown) located on a downstream side of the oil cooler 10. The air temperature sensor 32 may be disposed on an upstream side (open air inlet installed with an air cleaner, both not shown) of the supercharger and/or on a downstream side of the aftercooler 12. When the air temperature sensor 32 is disposed on the upstream side of the supercharger, the air temperature sensor 32 detects air temperature; when the air temperature sensor 32 is disposed on the downstream of the aftercooler 12, the sensor 32 detects compressed air temperature cooled by running through the aftercooler 12 after being compressed by the supercharger.

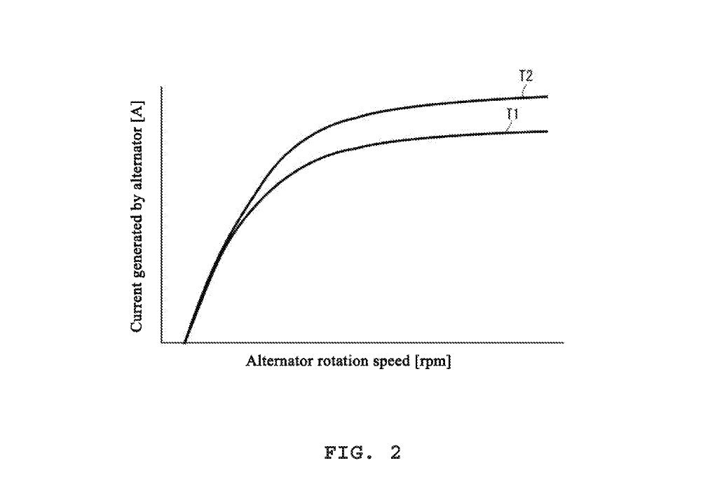

The alternator 4 coupled to the output shaft of an engine 34 generates electricity by being driven by the engine 34. The electricity generated by the alternator 4 is stored in the battery 26 electrically connected to the alternator 4. A solid line connecting the alternator 4 and the battery 26 in FIG. 1 illustrates an electrical power supply line. The current generated by the alternator 4 and an alternator 4 rotation speed have a relationship illustrated in e.g. FIG. 2; the higher the alternator 4 rotation speed is, the more current is generated; on the other hand, the lower the alternator 4 rotation speed is, the less current is generated. Also, as illustrated in FIG. 2, when ambient temperature of the alternator 4 is high (shown with a curve T1), the current generated in higher rotation speed area of the alternator 4 is less compared to when the ambient temperature of the alternator 4 is low (shown with a curve T2).

An engine 34 rotation speed is in proportional relationship with the alternator 4 rotation speed (for example, three times the engine 34 rotation speed is the same as the alternator 4 rotation speed). Thus, the higher the engine 34 rotation speed is, the more current is generated by the alternator 4; the lower the engine 34 rotation speed is, the less current is generated by the alternator 4. As illustrated in FIG. 1, a rotation speed detection means 36 for detecting the engine 34 rotation speed is attached to the engine 34.

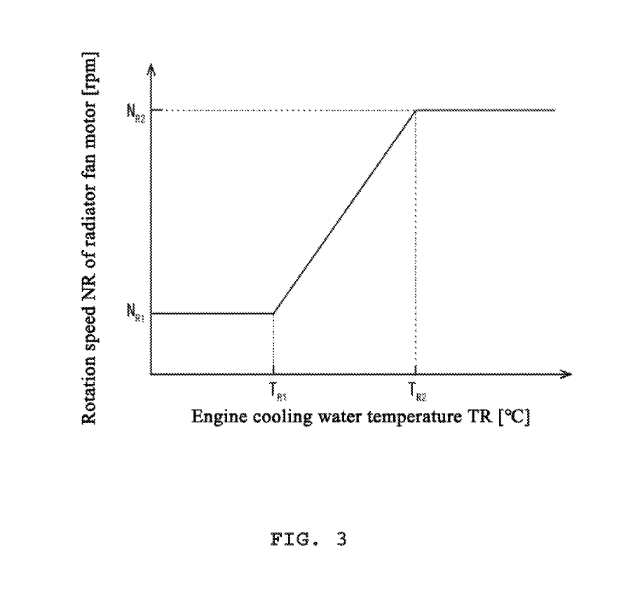

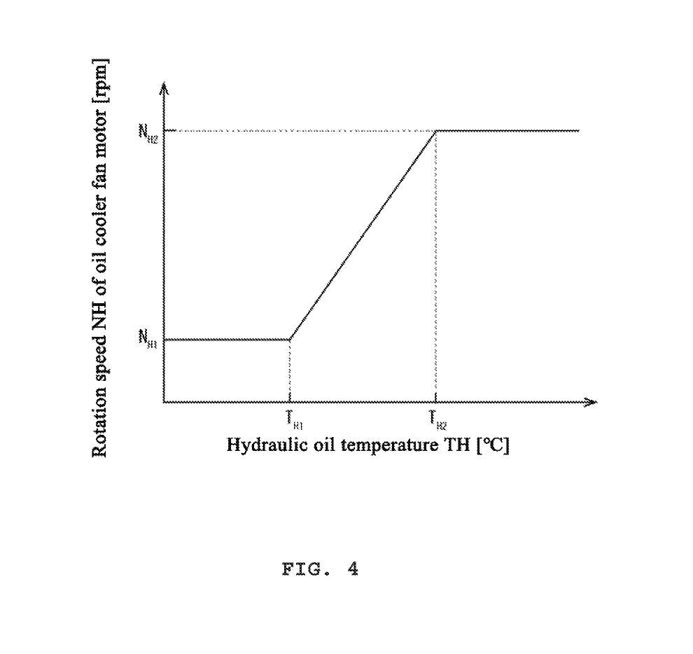

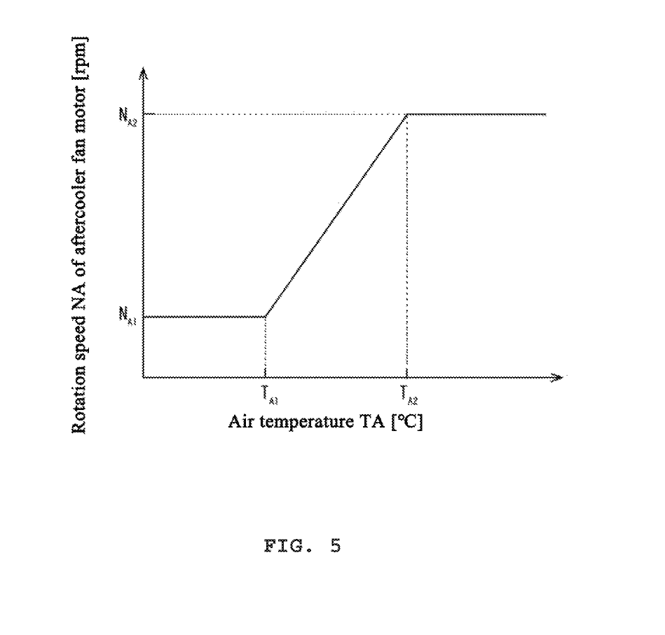

The control means 6 that may be comprised with a computer is electrically connected to the electric radiator fan motor 20, the electric oil cooler fan motor 22, the electric aftercooler fan motor 24, the cooling water temperature sensor 28, the hydraulic oil temperature sensor 30, the air temperature sensor 32, and the rotation speed detection means 36. The broken lines in FIG. 1 illustrate signal transmission lines. Also, the following information is stored in the control means 6 in advance. The information stored in the control means 6 is (1) a mapping of the alternator 4 rotation speed to the engine 34 rotation speed, (2) a mapping of current generated by the alternator 4 to the alternator 4 rotation speed as illustrated in FIG. 2, (3) values of current necessary for controlling other electric components than the electric motors 20, 22, and 24 (e.g., specific value of 40 A), (4) a mapping of rotation speeds of electric motors 20, 22, and 24 to values of current supplied to electric motors 20, 22, and 24, (5) a mapping of a rotation speed NR of the electric radiator fan motor 20 to an engine cooling water temperature TR illustrated in FIG. 3, (6) a mapping of a rotation speed NH of the electric oil cooler fan motor 22 to a hydraulic oil TH illustrated in FIG. 4, and (7) a mapping of a rotation speed NA of the electric aftercooler fan motor 24 to an air temperature TA illustrated in FIG. 5.

As illustrated in FIG. 3, as for the mapping of the rotation speed NR of the electric radiator fan motor 20 to the engine cooling water temperature TR, when the engine cooling water temperature TR is TR≤TR1, the rotation speed NR of the electric radiator fan motor 20 is constant NR1. Also, when the engine cooling water temperature TR is TR1<TR<TR2, the rotation speed NR of the electric radiator fan motor 20 is proportional to TR between NR1 and NR2. When the engine cooling water temperature TR is TR2≤TR, the rotation speed NR of the electric radiator fan motor 20 is constant NR2.

As illustrated in FIG. 4, as for the mapping of the rotation speed NH of the electric oil cooler fan motor 22 to the hydraulic oil temperature TH, when the hydraulic oil temperature TH is TH TH1, the rotation speed NH of the electric oil cooler fan motor 22 is constant NH1. Also, when the hydraulic oil temperature TH is TH1<TH<TH2, the rotation speed NH of the electric oil cooler fan motor 22 is proportional to TH between NH1 and NH2. Also, when the hydraulic oil temperature TH is TH2≤TH, the rotation speed NH of the electric oil cooler fan motor 22 is constant NH2.

As illustrated in FIG. 5, as for the mapping of the rotation speed NA of the electric aftercooler fan motor 24 to the air temperature TA, when the air temperature TA is TA≤TA1, the rotation speed NA of the electric aftercooler fan motor 24 is constant NA1. Also, when the air temperature TA is TA1<TA<TA2, the rotation speed NA of the electric aftercooler fan motor 24 is proportional to TA between NA1 and NA2. Also, when the air temperature TA is TA2 TA, the rotation speed NA of the electric aftercooler fan motor 24 is constant NA2.

When controlling the rotation speeds of electric motors 20, 22, and 24 in a control system 2 of blowing means for construction machines, first of all, the control means 6 computes the alternator 4 rotation speed using the engine 34 rotation speed input into the control means 6 from the rotation speed detection means 36 based on the mapping of the alternator 4 rotation speed to the engine 34 rotation speed.

Next, the control means computes the current generated by the alternator 4 from the alternator 4 rotation speed computed, as illustrated in FIG. 2, based on the mapping of the current generated by the alternator 4 to the alternator 4 rotation speed. When the control means 6 computes the current generated by the alternator 4, the control means 6 may use a mapping when the ambient temperature of the alternator 4 is relatively high (as shown with the curve T1 in FIG. 2). In addition, the control means 6 may detect the ambient temperature of the alternator 4 by means of a detection means (not shown), select a mapping (e.g. the curve T1 or T2 illustrated in FIG. 2) adapted for the ambient temperature of the alternator 4 by inputting the ambient temperature detected of the alternator 4 into the control means 6, and compute the current generated by the alternator 4.

Then, the control means 6 computes values of current available for use in electric motors 20, 22, and 24 by subtracting the values of current necessary for controlling other electric components than the electric motors 20, 22, and 24 from the computed current generated by the alternator 4. The values of current available for use in electric motors 20, 22, and 24 may be one and the same; that is, they may be the value of current generated by the alternator 4 which is subtracted by the values of current necessary for controlling other electric components than the electric motors 20, 22, and 24, and then divided evenly.

Then, the control means 6 computes the upper limit rotation speeds of electric motors 20, 22, and 24 from values of current available for use in electric motors 20, 22, and 24 based on the mappings of the rotation speeds of electric motors 20, 22, and 24 to values of current supplied to electric motors 20, 22, and 24; that is, it computes an upper limit rotation speed NR_{MAX} of the electric radiator fan motor 20, an upper limit rotation speed NH_{MAX} of the electric oil cooler fan motor 22, and an upper limit rotation speed NA_{MAX} of the electric aftercooler fan motor 24.

Thereafter, as illustrated in FIG. 3, based on the mapping of the rotation speed NR of the electric radiator fan motor 20 to the engine cooling water temperature TR, the control means 6 computes the rotation speed NR of the electric radiator fan motor 20 from the engine cooling water temperature TR detected by the cooling water temperature sensor 28. Also, as illustrated in FIG. 4, based on the mapping of the rotation speed NH of the electric oil cooler fan motor 22 to the hydraulic oil temperature TH, the control means 6 computes the rotation speed NH of the electric oil cooler fan motor 22 from the hydraulic oil temperature TH detected by the hydraulic oil temperature sensor 30. Then, as illustrated in FIG. 5, based on the mapping of the rotation speed NA of the electric aftercooler fan motor 24 to the air temperature TA, the control means 6 computes the rotation speed NA of the electric aftercooler fan motor 24 from the air temperature TA detected by the air temperature sensor 32.

Thereafter, the control means 6 compares the upper limit rotation speed NR_{MAX} of the electric radiator fan motor 20 with the rotation speed NR based on the engine cooling water temperature TR; if NR≤NR_{MAX}, the control means 6 outputs the rotation speed NR based on the engine cooling water temperature TR as a control signal to the electric radiator fan motor 20; if NR_{MAX}<NR, the control means 6 outputs the upper limit rotation speed NR_{MAX} based on value of current available for use as the control signal to the electric radiator fan motor 20.

Also, the control means 6 compares the upper limit rotation speed NH_{MAX} of the electric oil cooler fan motor 22 with the rotation speed NH based on the hydraulic oil temperature TH; if NH≤NH_{MAX}, the control means 6 outputs the rotation speed NH based on the hydraulic oil temperature TH as a control signal to the electric oil cooler fan motor 22; if NH_{MAX}<NH, the control means 6 outputs the upper limit rotation speed NH_{MAX} based on value of current available for use as the control signal to the electric oil cooler fan motor 22.

Also, the control means 6 compares the upper limit rotation speed NA_{MAX} of the electric aftercooler fan motor 24 with the rotation speed NA based on the air temperature TA; if NA≤NA_{MAX}, the control means 6 outputs the rotation speed NA based on the air temperature TA as a control signal to the electric aftercooler fan motor 24; if NA_{MAX}<NA, the control means 6 outputs the upper limit rotation speed NA_{MAX} based on value of current available for use as the control signal to the electric aftercooler fan motor 24.

As described above, in the control system 2 of blowing means for construction machines, since the control means 6 determines the upper limit rotation speeds of electric motors 20, 22, and 24 based on the current generated by the alternator 4 and controls the rotation speeds of electric motors 20, 22, and 24 based on the temperatures TR, TH, and TA detected by the temperature sensors 28, 30, and 32 while each rotation speed is below each upper limit rotations, so the loss of charging amount of the battery 26 can be prevented even if the engine 34 rotation speed is low and the alternator 4 generates less electricity.

Although the embodiment illustrated in figures illustrates an example having a plurality of heat exchangers, fans, electric motors, and temperature sensors, the heat exchanger, fan, electric motor, and temperature sensor may be singular, or a single fan may be driven by a single electric motor with respect to a plurality of heat exchangers. Also, although the embodiment illustrated in figures illustrates the example having a plurality of fans driven respectively by a plurality of electric motors, fans driven by electric motors may be mixed with fans driven by other driving power sources than electric motor (e.g., an engine or hydraulic motor).

### REFERENCE NUMERALS

2: Control system of blowing means for construction machines
4: Alternator
6: Control means
8: Radiator
10: Oil cooler
12: Aftercooler
14: Radiator fan
16: Oil cooler fan
18: Aftercooler fan
20: Electric radiator fan motor
22: Electric oil cooler fan motor
24: Electric aftercooler fan motor
26: Battery
28: Cooling water temperature sensor
30: Hydraulic oil temperature sensor
32: Air temperature sensor
34: Engine
36: Rotation speed detection means

1. A control system of blowing means for construction machines, the control system comprising: a heat exchanging means; a blowing means for blowing air to the heat exchanging means; an electric driving means for driving the blowing means; a temperature detecting means for detecting temperature of fluids running through the heat exchanging means; an alternator generating electricity by being driven by an engine; and a control means for determining an upper limit rotation speed of the electric driving means based on current generated by the alternator and controlling a rotation speed of the electric driving means based on the temperature detected by the temperature detecting means in case of the rotation speed being below the upper limit rotation speed.

2. The control system of blowing means for construction machines according to claim 1, wherein the heat exchanging means having a plurality of heat exchangers; the blowing means having a plurality of fans disposed facing to the each of a plurality of heat exchangers; the electric driving means having a plurality of electric motors for driving the each of a plurality of fans; and the temperature detecting means having a plurality of temperature sensors for detecting temperature of fluids running through the each of a plurality of heat exchangers; and
the control means determining, the upper limit rotation speed of the each of a plurality of electric motors based on the current generated by the alternator and controlling each rotation speed of a plurality of electric motors based on the temperature detected by the each of a plurality of temperature sensors in case of each rotation speed being, below the each of a plurality of upper limit rotation speeds.

3. The control system of blowing means for construction machines according to claim 1, wherein the control means having a rotation speed detection means for detecting an engine rotation speed;
the control means already storing a mapping of an alternator rotation speed to the engine rotation speed and a mapping of the current generated by the alternator to the alternator rotation speed; and
the control means computing the alternator rotation speed based on the engine rotation speed detected by the rotation speed detection means and computing the current generated by the alternator based on the alternator rotation speed computed.

4. The control system of blowing means for construction machines according to claim 2, wherein the control means having a rotation speed detection means for detecting an engine rotation speed;
the control means already storing a mapping of an alternator rotation speed to the engine rotation speed and a mapping of the current generated by the alternator to the alternator rotation speed; and
the control means computing the alternator rotation speed based on the engine rotation speed detected by the rotation speed detection means and computing the current generated by the alternator based on the alternator rotation speed computed.
